(19) United States
(12) Patent Application Publication
(10) Pub. No.: US 2009/0258297 A1
(43) Pub. Date: Oct. 15, 2009

(54) Battery

(76) Inventors: Stuart M. Davis, Norfolk, MA (US); Nikolay K. Iltchev, Norfolk, MA (US); Gary A. Miller, Milton, MA (US)

Correspondence Address: FISH & RICHARDSON P.C., P.O. BOX 1022, MINNEAPOLIS, MN, 55440-1022, US

(21) Appl. No.: 12/103,366

(22) Filed: Apr. 15, 2008

(51) Int. Cl. H01M 4/50; H01M 4/42; H01M 6/00

(52) U.S. Cl. 429/224; 429/229; 29/623.1

(57) ABSTRACT

Primary alkaline batteries include cathodes containing manganese dioxide and anodes including zinc. The weight ratio of the manganese dioxide to zinc is relatively low because the manganese dioxide has a relatively high oxygen content.

### TECHNICAL FIELD

This invention relates to batteries.

### BACKGROUND

Batteries are commonly used as electrical energy sources. A battery contains a negative electrode, typically called the anode, and a positive electrode, typically called the cathode. The anode contains an active material that can be oxidized. The cathode contains or consumes an active material that can be reduced. The anode active material is capable of reducing the cathode active material. The battery contains an ionically conductive electrolyte which permeates the anode and cathode and also occupies the space between these two electrodes. The electrolyte normally includes a solution consisting of a solvent and a dissolved ionic substance. The battery also includes a separator material disposed between the anode and the cathode which electronically insulates the anode from the cathode but is permeable to the electrolyte solution and its ions.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

There is a growing need for batteries suitable for high power application. Modern electronic devices such as cellular phones, digital cameras and toys, flash units, remote control toys, camcorders and high intensity lamps are examples of such high power applications. Such devices require high current drain rates of between about 0.5 and 2 Amp, typically between about 0.5 and 1.5 Amp. Correspondingly, they require operation at power demands between about 0.5 and 2 Watt.

Commercial primary alkaline batteries often include cathodes including manganese dioxide and anodes including zinc. Such batteries often have a cylindrical housing and come in standard AA, AAA, AAAA, C, and D sizes defined by International Electrotechnical Commission standards. A AA battery can have a maximum length of 50.5 mm with a minimum distance from the pip end to the negative contact of 49.2 mm and a diameter ranging from 13.5 mm to 14.5 mm. AAAA battery can have a maximum length of 44.5 mm with a minimum distance from the pip end to the negative contact of 43.3 mm and a diameter ranging from 9.5 mm to 10.5 mm. AAAAA battery can have a maximum length of 42.5 mm with a minimum distance from the pip end to the negative contact of 41.4 mm and a diameter ranging from 7.7 mm to 8.3 mm. A C battery can have a maximum length of 50.0 mm with a minimum distance from the pip end to the negative contact of 48.5 mm and a diameter ranging from 24.9 mm to 26.2 mm. A D battery can have a maximum length of 61.5 mm with a minimum distance from the pip end to the negative contact of 59.5 mm and a diameter ranging from 32.3 mm to 34.2 mm.

In commercial primary alkaline batteries, it is common for the total milli-ampere-hour (mAh) capacity of the manganese dioxide in the cathode to exceed the total milli-ampere-hour (mAh) capacity of the zinc in the anode. The ratio of the total cathode mAh capacity to the total anode mAh capacity is known as the cell “balance”. When the cell balance is greater than 1.00, and there is an excess of manganese dioxide electrochemical capacity over zinc electrochemical capacity, the cell is said to be “anode limited”. In such designs, as the battery is discharged, the zinc is fully consumed by oxidation reactions prior to the exhaustion of the manganese dioxide via reduction reactions. Such anode limited designs prevent deep discharge gassing. Deep discharge gassing can take place in a battery when there is insufficient manganese dioxide capacity compared to zinc capacity; that is, when the electrochemical balance is less than 1.00. When such a battery discharges to the point of completely exhausting the manganese dioxide, some unused zinc still remains. The oxidation of any remaining zinc can furnish electrons to the exhausted manganese dioxide cathode through the external electrical connection, for example, a load. Reduction reactions involving water then occur on the exhausted manganese dioxide cathode and hydrogen gas is produced. Such deep discharge gassing can cause the battery to vent or leak.

### SUMMARY

The invention generally relates to primary alkaline batteries that include cathodes including manganese dioxide and anodes including zinc. Significantly, the batteries include a relatively low weight ratio of manganese dioxide to zinc because the manganese dioxide has a relatively high oxygen content provided, for example, by ozonation. Particularly, the batteries include less, for example, weight and/or volume of, manganese dioxide, which allows inclusion of more other active materials, such as zinc or electrolyte material, to optimize the battery performance. In each battery, the total capacities of the manganese dioxide and the zinc are both increased while the total capacity of the manganese dioxide is maintained to be higher than the total capacity of the zinc. Such batteries demonstrate good discharge behaviors and provide long service life.

In one aspect, the invention features primary alkaline batteries that include an anode that contains zinc and a cathode that contains MnOₓ, where x is greater than 1.97, for example, greater than 1.98 or 1.99. When the battery is a AA battery, the battery has a weight ratio of MnOₓ to zinc of less than 2.30, for example, less than 2.25, 2.20, 2.10 or 2.09. When the battery is a AAA battery, the battery has a weight ratio of MnOₓ to zinc of less than 2.36, for example, less than 2.30, 2.25, or 2.23. When the battery is a AAAA battery, the battery has a weight ratio of MnOₓ to zinc of less than 2.76, for example, less than 2.70, 2.65, 2.60, 2.50, 2.40, 2.39 or 2.23. When the battery is a C battery, the battery has a weight ratio of MnOₓ to zinc of less than 2.28, for example, less than 2.26, 2.25, 2.22, or 2.15. When the battery is a D battery, the battery has a weight ration of MnOₓ to zinc of less than 2.23, for example, 2.15 or 2.10.

In another aspect, the invention features an AA battery that has an available internal volume of greater than 6.10 cm³, for example, 6.20 cm³, or 6.30 cm³ and includes a cathode that contains less than 10.00 grams of manganese dioxide and an anode that contains zinc. The formula of manganese dioxide and the weight ratio of manganese dioxide to zinc are described above.

The term “available internal volume”, as used herein, is defined as the volume inside the battery which could be occupied by the combined volume of cathode materials, anode materials, electrolyte and void space. Void space includes the volume inside the battery which is occupied only by gases and vapors. Void space can be distributed within the cathode, anode, separator or electrolyte or any combination of these or be located in a distinct region, outside of these components, for example in the head space of the battery. The volume occupied by the anode current collector, the can walls and the sealing grommet do not contribute to the “available internal volume”.

In another aspect, the invention features a method of making primary alkaline batteries. The method includes incorporating a cathode including manganese dioxide that has been ozonated and an anode including zinc into a housing. The batteries include the weight ratio of manganese dioxide to zinc described above. When the battery is a AA battery, the battery has an available internal volume and a weight of manganese dioxide as described above.

All publications, patent applications, patents, and other references mentioned herein are incorporated by reference herein in their entirety.

Other features and advantages of the invention will be apparent from the following detailed description, and from the claims.

### DESCRIPTION OF DRAWINGS

FIG. 1 is a schematic diagram of a battery.

Like reference symbols in the various drawings indicate like elements.

### DETAILED DESCRIPTION

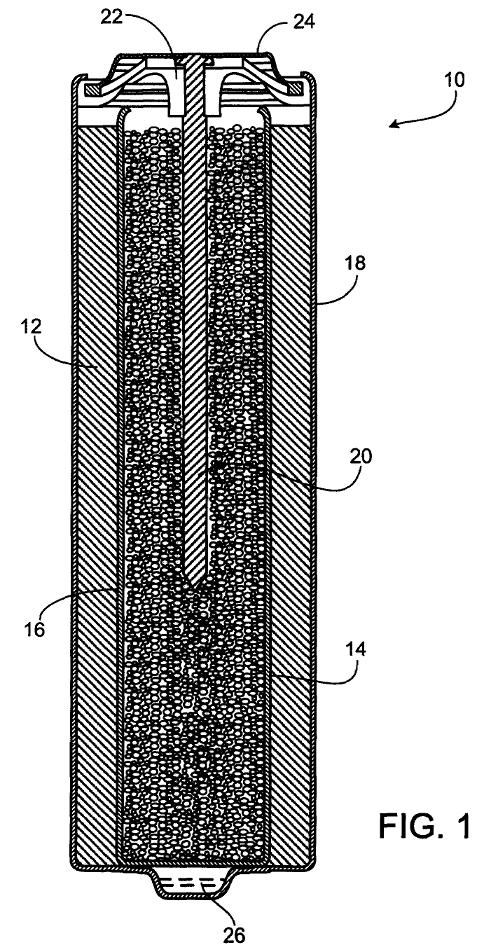

Referring to FIG. 1, a primary alkaline battery 10 includes a cathode 12, an anode 14, a separator 16 and a cylindrical housing 18. Battery 10 also includes current collector 20, seal 22, and a negative metal end cap 24, which serves as the negative terminal for the battery. A positive pip 26, which serves the positive terminal of the battery, is at the opposite end of the battery from the negative terminal. An electrolytic solution is dispersed throughout battery 10. Battery 10 can be a AA, AAA, AAAA, C, or D battery.

Cathode 12 includes manganese dioxide. It may also include carbon particles, a binder, and other additives.

Manganese dioxide used in cathode 12 generally has a purity of at least about 90 percent by weight. Manganese dioxide can be, for example, electrolytic manganese dioxide (EMD) or chemical manganese dioxide (CMD). EMD can be manufactured from direct electrolysis of a bath of manganese sulfate and sulfuric acid. Processes for the manufacture of EMD and its properties appear in Batteries, edited by Karl V. Kordesch, Marcel Dekker, Inc., New York, Vol. 1, (1974), p. 433-488. CMD is typically made by a process known in the art as the “Sedema process”, a chemical process disclosed by U.S. Pat. No. 2,956,860 (Welsh) for the manufacture of battery grade MnO₂ by employing the reaction mixture of MnSO₄ and an alkali metal chlorate, preferably NaClO₃. Distributors of manganese dioxide include Tronox (Trona D), Chem-Metals Co., Tosoh, Delta Manganese, Mitsui Chemicals, JMC, and Xiangtan.

Manganese dioxide is a non-stoichiometric material due to the presence of Mn+⁴ vacancies (missing Mn+⁴ ions replaced by 4 protons) and hydroxyl groups which results in Mn+³ defects for the sake of charge neutrality. The formula for conventional battery grade manganese dioxide, whether in the form of EMD or CMD, can be represented by the overall formula MnOₓ, 1.950<x<1.970.

The value x is also called the “degree of peroxidation”. It is related to the average valence of manganese in the MnOₓ, which can be expressed as Mn valence=2x. Thus, if the overall formula is MnO_{1.92} the average valence of manganese is +3.84, assuming a valence of −2 for oxygen, and if the formula is MnO_{1.96} the average valence of manganese is +3.92. The term average valence, as used herein, is intended to be a simple arithmetic average, that is, the sum of the valence of each manganese atom in the manganese dioxide sample divided by the total number of manganese atoms.

Manganese dioxide included in cathode 12 is ozonated, for example, according to the procedures described in U.S. Ser. No. 12/061,136, filed Apr. 2, 2008 and Wang et al., U.S. Pat. No. 6,162,561. Ozonated MnOₓ has a high “x” value, for example, larger than, e.g., 1.970, 1.975, 1.980, 1.985, 1.990, 1.995, or 2.000. Alternatively, manganese dioxide can be oxidized to reach a high “x” value using other oxidation methods with other oxidants.

Without being bound by theory, it is believed that an electrochemical cell containing manganese dioxide having a higher average valence, or “x” value, has better cell performance. For example, gravimetric capacity that indicates the discharge capacity of each gram of the cathode material can be enhanced. Gravimetric capacity, as used herein, is defined as the number of milli-ampere hours that can be obtained by fully discharging one gram of material.

In some embodiments, ozonated MnOₓ has a gravimetric capacity greater than, for example, about 380 mAh/g, 385 mAh/g, or 390 mAh/g, and/or up to, for example, about 420 mAh/g, 415 mAh/g, or 410 mAh/g. The total capacity of the cathode active material in the cathode 12 is the total amount of cathode active material in grams multiplied by the gravimetric capacity of the cathode active material. Due to the high gravimetric capacity of the ozonated MnOₓ, cathode 12 can include an adjusted, for example, lower, amount of cathode active material and still reach a desired high total capacity. This further allows variations of the amount of materials included in the other components, for example, anode 12, of the battery 10 and/or the electrolyte. Such adjustments and variations can optimize cell performance on an overall cell level.

When battery 10 is a AA battery, the battery 10 includes an available internal volume, for example, of greater than 6.10 cm³, 6.20 cm³, or 6.30 cm³ and/or less than, for example, 7.50 cm³. In some embodiments, cathode 12 of the AA battery includes, for example, less than about 10.0 g, 9.9 g, or 9.8 g, ozonated MnOₓ.

The ozonated MnOₓ has a density, for example, greater than about 4.47 g/cm³, 4.49 g/cm³, 4.51 g/cm³, or 4.54 g/cm³. Commercial MnOₓ, particularly EMD often has a density of about 4.45 g/cm³. Density, as used herein, is the total weight of the material, solids and voids included, divided by the space occupied only by solids and closed voids. Space occupied by open voids which communicate to the exterior of the MnOₓ particles, is not counted in the volume. Density of MnOₓ powder can be measured by helium pycnometry, in which the MnOₓ sample is first weighed in air to establish the sample weight and then placed and sealed in a calibrated chamber with a known volume. A known quantity of pressurized helium gas is introduced into the chamber and the final pressure within the calibrated chamber is measured. The volume of the solid portion of the sample, including any closed voids, is calculated, using, for example, ideal gas laws, to be the volume in the chamber that is not accessible to helium gas. The density is computed as the quotient of the measured MnOₓ weight and the calculated volume. This procedure is carried out at constant temperature to avoid any spurious pressure changes. Commercial helium pycnometers are offered to carry out repetitive measurements and to calculate the density. Such instruments may be purchased from Quantachrome or Micromeritics.

Without being bound by theory, it is believed that the higher density observed for ozonated EMD is due to a lattice contraction that occurs as the average Mn oxidation state is increased. Since Mn⁴⁺ ions occupy less volume than Mn³⁺ ions, when the population of Mn⁴⁺ is increased and that of Mn³⁺ is decreased after ozonation, the lattice of MnOₓ shrinks.

Cathode 12 that includes a high density ozonated MnOₓ can occupy even less internal space of the battery 10 and thus allows more room for inclusion of other materials.

The carbon particles used in cathode 12 may be graphite particles, carbon black, or their combination. The graphite can be synthetic graphite including an expanded graphite, natural graphite including an expanded natural graphite, or a blend thereof. Suitable natural graphite particles can be obtained from, for example, Brazilian Nacional de Grafite (Itapecerica, MG Brazil, NdG MP-0702x grade) or Superior Graphite Co. (Chicago, Ill., ABG-grade). Suitable expanded graphite particles can be obtained, for example, from Chuetsu Graphite Works, Ltd. (Chuetsu grades WH-20A and WH-20AF) of Japan or Timcal America (Westlake, Ohio, BNB-Grade).

Examples of binders include polyethylene, polyacrylic acid, or a fluorocarbon resin, such as PVDF or PTFE. An example of a polyethylene binder is sold under the trade name COATHYLENE HA-1681 (available from Hoechst or DuPont).

Examples of other additives are described in, for example, U.S. Pat. Nos. 5,698,315, 5,919,598, and 5,997,775 and U.S. application Ser. No. 10/765,569.

An electrolyte solution can be dispersed through cathode 12. The electrolyte can be an aqueous solution of alkali hydroxide, such as potassium hydroxide or sodium hydroxide. The electrolyte can also be an aqueous solution of saline electrolyte, such as zinc chloride, ammonium chloride, magnesium perchlorate, magnesium brominde, or their combinations.

Anode 14 includes zinc, and optionally, a gelling agent and minor amounts of additives, such as a gassing inhibitor. In addition, a portion of the electrolyte solution discussed above is dispersed throughout the anode. The zinc can be zinc or zinc alloy. Examples of a gelling agent include a polyacrylic acid, a grafted starch material, a salt of a polyacrylic acid, a carboxymethylcellulose, a salt of a carboxymethylcellulose (e.g., sodium carboxymethylcellulose) or combinations thereof. Examples of a gassing inhibitor include inorganic materials, such as bismuth, tin, indium, their salts, or their oxides. Alternatively, the gassing inhibitor includes an organic compound, such as a phosphate ester, an ionic surfactant or a nonionic surfactant, a quaternary ammonium salt or a polymeric quaternary ammonium compound.

Similar to the cathode active material in cathode 12, zinc or zinc alloy in anode 14 also is characterized by a gravimetric capacity. Zinc or zinc alloy can have a gravimetric capacity of about 820 mAh/g. The total capacity of the anode active material in the anode 14 is the total amount of anode active material in grams multiplied by the gravimetric capacity of the anode active material.

In some embodiments, in battery 10, the total capacity of the cathode active material is larger than the total capacity of the anode active material. Accordingly, the weight ratio of cathode active material, for example, MnOₓ, to anode active material, for example, zinc or zinc alloy, is controlled to be within a range. To have a battery 10 that exhibits a higher average operating voltage, a longer discharge duration, and superior high current drain capacity, it is desirable for both cathode 12 and anode 14 to have high total capacities but also to maintain the capacity balance, which is the ratio of the total capacity of the cathode active material in battery 10 to the total capacity of the anode active material in battery 10, to be greater than 1.00.

When battery 10 is a AA battery, the weight ratio of ozonated MnOₓ to zinc or zinc alloy is less than, for example, about 2.33, 2.30, 2.25, 2.20, 2.15, 2.10, or 2.08 and/or greater than, for example, about 2.07. In such embodiments, the capacity balance, which is the ratio of the total capacity of the ozonated MnOₓ to the total capacity of zinc or zinc alloy is greater than, for example, 1.05, 1.04, 1.03, 1.02, 1.01 or 1.00 and/or less than, for example, 1.13. When battery 10 is a AAA battery, the weight ratio of ozonated MnOₓ to zinc or zinc alloy is less than, for example, about 2.41, 2.40, 2.36, 2.30, 2.28, 2.25, 2.20, 2.10 or 2.08 and/or greater than, for example, about 2.07. In such embodiments, the capacity balance, as defined for the AA battery above, is greater than, for example, 1.09, 1.05, 1.02 or 1.00 and/or less than 1.16.

When battery 10 is a AAAA battery, the weight ratio of ozonated MnOₓ to zinc or zinc alloy is less than, for example, about 2.82, 2.80, 2.76, 2.70, 2.60, 2.50, 2.40, 2.30, 2.20, 2.10 or 2.08 and/or greater than, for example, about 2.07. In such embodiments, the capacity balance, as defined for the AA and AAA batteries above is greater than, for example, 1.27, 1.25, 1.20, 1.10, 1.05 or 1.00 and/or less than, for example, 1.36.

When battery 10 is a C battery, the weight ratio of ozonated MnOₓ to zinc or zinc alloy is less than, for example, about 2.34, 2.30, 2.28, 2.26, 2.22, 2.10 or 2.08 and/or greater than, for example, about 2.07. In such embodiments, the capacity balance, as defined for the AA, AAA, and AAAA batteries above, is greater than, for example, 1.05, 1.04, 1.03, 1.02, 1.01 or 1.00 and/or less than, for example, 1.13.

When battery 10 is a D battery, the weight ratio of ozonated MnOₓ to zinc or zinc alloy is less than, for example, about 2.29, 2.25, 2.23, 2.20, 2.15, 2.10 or 2.08, and/or greater than, for example, about 2.07. In such embodiments, the capacity balance, as defined for the AA, AAA, AAAA, and C batteries above, is greater than, for example, 1.03, 1.02, 1.01 or 1.00, and/or less than, for example, 1.10.

Separator 16 can be a conventional alkaline battery separator. In other embodiments, separator 16 can include a layer of cellophane combined with a layer of non-woven material. The separator also can include an additional layer of non-woven material. Housing 18 can be a conventional housing commonly used in primary alkaline batteries, for example, nickel plated cold-rolled steel. Current collector 20 can be made from a suitable metal, such as brass. Seal 22 can be made, for example, of a nylon resin.

### EXAMPLES

In this illustrative example, four groups of AA batteries, T1, T2, T3, and T4 are prepared using the same conventional cell hardware and cell construction procedure. The four groups of batteries are tested afterwards.

Each group T1 battery follows a standard commercial AA cell design and includes 10.219 g of conventional EMD, 4.371 g of zinc, and 3.822 g of electrolyte. Each group T1 battery also includes about 3.0% of void volume in its internal space. The weight ratio of EMD to zinc in each group T1 battery is about 2.338, and the capacity balance is about 1.055.

Each group T2 battery includes 9.963 g of ozonated MnOₓ, 4.521 g of zinc, and 3.965 g of electrolyte. Each group T2 battery also includes about 3.0% if void volume in its internal space. The weight ratio of ozonated MnOₓ to zinc in each group T2 battery is about 2.204, and the capacity balance is about 1.053.

Each group T3 battery includes 10.219 g of ozonated MnOx, 4.371 g of zinc, and 3.822 g of electrolyte. Each group T3 battery also includes about 4.1% of void volume in its internal space. The weight ratio of ozonated MnOₓ to zinc in each group T3 battery is about 2.338, and the capacity balance is about 1.118.

Each group T4 battery includes 9.963 g of EMD, 4.521 g of zinc, and 3.965 g of electrolyte. Each group T4 battery also includes about 2.0% of void volume in its internal space. The weight ratio of EMD to zinc in each group T4 battery is about 2.204, and the capacity balance is about 0.994.

In the first test, the four groups of batteries are tested on nine standard device tests. The tests include using the batteries within one or two weeks after preparation on a toy, a CD player, a digital camera, a remote control, an audio, and a clock. The tests also include storing the batteries at about 60° C. for a week and then discharging the batteries on a toy test. In addition, the tests include subjecting the batteries to temperature transportation cycles (TTC) for two weeks before discharging the batteries on a toy or a CD player test. In particular, the TTC cycle simulates the time-temperature profile of summer shipment. Each TTC lasts about 24 hours, during which the temperature of the battery is cycled from about 28° C. to about 55° C. and back to about 28° C. Four to six batteries from each group are involved in each test. Tests are conducted on a computer controlled Macor battery test system, employing simulated constant resistance, constant current or constant Wattage loads, as required by the test regime.

The total service hours delivered by each group of batteries on each test before each battery's voltage falls below the final end-point voltage (EPV) which is, for example, 1.05V for digital camera, 0.9V for CD player, 0.8V for toy test, 0.9V for audio, 1.0V for remote control and 0.9V for clocks, are measured. The total service hours of each group on one test are represented by the average of all batteries tested and compared between different groups.

Battery groups T2 and T3 each demonstrates an increase of about 2% to about 25% compared to battery group T1 in the nine tests. In particular, battery group T2 has an increase of about 5% in seven tests and battery group T3 has an increase of about 2-3% in eight tests. Battery group T4 also demonstrates increased service hours compared to battery group T1 in seven tests, with an increase ranging from about 3% to about 15%. However, in one test, battery group T4 shows decreased service hours, with a decrease of about 1%, compared to battery group T1.

The total Watt hours delivered by each group of batteries on each device before the battery voltage falls below the final EPV are measured and compared. Battery groups T2 and T3 each demonstrate an increase of about 3% to about 25% compared to battery group T1 in the nine tests. In particular, battery group T2 has an increase of about 6-7% in seven tests and battery group T3 has an increase of about 5% in eight tests. Battery group T4 also demonstrates increased Watt hours compared to battery group T1 in seven tests, with an increase ranging between about 3% to about 15%. However, in two tests, battery group T4 shows decreased Watt hours, of about 1% in each test, compared to battery group T1.

Following the aforementioned tests, the discharged cells are recovered and are subjected to a short circuit condition for two weeks. The cells are then removed from the short circuit condition and are immediately tested for gas volumes within each cell.

Each cell is placed in a sealed chamber, the pressure of which is measured by an oil filled manometer. The seal on the cell is punctured and the final pressure in the chamber is measured. The volume of gas contained in the each cell is calculated based on the measured pressures.

Battery groups T1 and T2 show zero or minimal gas within the discharged batteries. Battery group T3 shows less than about 0.5 ml gas within each discharged battery. Battery group T4 contains 1 to 9 ml gas in each discharged battery.

Thus it is seen that the weight ratio of ozonated MnOₓ to Zn can be reduced below that of a conventional battery design (e.g., from 2.338 in group T1 to 2.204 in group T2) without increasing gas volumes within the cells after deep discharge of the cells. However when a similar battery design with un-ozonated EMD is employed, for example, in battery group T4, with the weight ratio of MnOₓ to Zn being decreased below that of a conventional design (i.e. from 2.338 in group T1 to 2.204 in group T4), there is an increase in gas volume from virtually zero to a range of 1 to 9 ml of gas per battery. Although both groups T2 and T4, each with a lower weight ratio of MnOₓ to Zn show performance increases over group T1, only group T2 is acceptable from the standpoint of deep discharge gassing. The use of highly oxidized MnOₓ, for example ozonated EMD, allows for a lower weight ratio of MnOₓ to zinc to be employed, consequently more room in the battery for both electrolyte and zinc. This leads to increased battery performance, without penalty in deep discharge gassing.

Other embodiments are in the claims.

What is claimed is:

1. AAA battery comprising:
a AA housing; and
an anode including zinc and a cathode including MnOₓ, where x is greater than 1.97;
wherein the battery has a weight ratio of MnOₓ to zinc of less than 2.30.

2. The AA battery of claim 1, wherein the weight ratio of MnOₓ to zinc is less than 2.25.

3. The AA battery of claim 1, wherein the weight ratio of MnOₓ to zinc is less than 2.20.

4. The AA battery of claim 1, wherein the weight ratio of MnOₓ to zinc is less than 2.15.

5. The AA battery of claim 1, wherein the weight ratio of MnOₓ to zinc is less than 2.10.

6. The AA battery of claim 1, wherein the weight ratio of MnOₓ to zinc is less than 2.08.

7. The AA battery of claim 1, wherein the weight ratio of MnOₓ to zinc is greater than 2.07.

8. The AA battery of claim 1, wherein x is greater than 1.98.

9. The AA battery of claim 1, wherein x is greater than 1.99.

10. The AA battery of claim 1, wherein MnOₓ in the cathode has a weight of less than 10.00 grams.

11. The AA battery of claim 1, wherein MnOₓ has a gravimetric capacity of greater than 374 mAh per gram of MnOₓ.

12. AAAA battery comprising:
a AAA housing; and
an anode including zinc and a cathode including MnOₓ where x is greater than 1.97;
wherein the battery has a weight ratio of MnOₓ to zinc of less than 2.36.

13. The AAA battery of claim 12, wherein the weight ratio of MnOₓ to zinc is less than 2.30.

14. The AAA battery of claim 12, wherein the weight ratio of MnOₓ to zinc is less than 2.23.

15. The AAA battery of claim 12, wherein the weight ratio of MnOₓ to zinc is greater than 2.22.

16. The AAA battery of claim 12, wherein x is greater than 1.98.

17. The AAA battery of claim 12, wherein x is greater than 1.99.

18. AAAAA battery comprising:
a AAAA housing; and
an anode including zinc and a cathode including MnOₓ, where x is greater than 1.97;
wherein the battery has a weight ratio of MnOₓ to zinc of less than 2.76.

19. The AAAA battery of claim 18, wherein the weight ratio of MnOₓ to zinc is less than 2.70.

20. The AAAA battery of claim 18, wherein the weight ratio of MnOₓ to zinc is less than 2.60.

21. The AAAA battery of claim 18, wherein the weight ratio of MnOₓ to zinc is less than 2.50.

22. The AAAA battery of claim 18, wherein the weight ratio of MnOₓ to zinc is less than 2.40.

23. The AAAA battery of claim 18, wherein the weight ratio of MnOₓ to zinc is less than 2.30.

24. The AAAA battery of claim 18, wherein the weight ratio of MnOₓ to zinc is less than 2.25.

25. The AAAA battery of claim 18, wherein the weight ratio of MnOₓ to zinc is less than 2.22.

26. The AAAA battery of claim 18, wherein x is greater than 1.98.

27. The AAAA battery of claim 18, wherein x is greater than 1.99.

28. AC battery comprising:
a C housing; and
an anode including zinc and a cathode including MnOₓ, where x is greater than 1.97;
wherein the battery has a weight ratio of MnOₓ to zinc of less than 2.28.

29. The C battery of claim 28, wherein the weight ratio of MnOₓ to zinc is less than 2.22.

30. The C battery of claim 28, wherein x is greater than 1.98.

31. The C battery of claim 28, wherein x is greater than 1.99.

32. A D battery comprising:
a D housing; and
an anode including zinc and a cathode including MnOₓ, where x is greater than 1.97;
wherein the battery has a weight ratio of MnOₓ to zinc of less than 2.23.

33. The D battery of claim 32, wherein the battery has a weight ratio of MnOₓ to zinc of less than 2.15.

34. The D battery of claim 32, wherein the weight ratio of MnOₓ to zinc is less than 2.10.

35. The D battery of claim 32, wherein x is greater than 1.98.

36. The D battery of claim 32, wherein x is greater than 1.99.

37. A method of making a AA battery, the method comprising:
incorporating a cathode including manganese dioxide that has been ozonated and an anode including zinc into a AA housing, wherein the weight ratio of manganese dioxide to zinc is less than 2.30.

38. The method of claim 37, wherein the weight ratio of manganese dioxide to zinc is less than 2.15.

39. The method of claim 37, wherein the manganese dioxide has a formula MnOₓ, where x is greater than 1.97.

40. The method of claim 39, wherein x is greater than 1.98.

41. A method of making a AAA battery, the method comprising:
incorporating a cathode including manganese dioxide that has been ozonated and an anode including zinc into a AAA housing, wherein the weight ratio of manganese dioxide to zinc is less than 2.36.

42. The method of claim 41, wherein the weight ratio of manganese dioxide to zinc is less than 2.23.

43. The method of claim 41, wherein the manganese dioxide has a formula MnOₓ, where x is greater than 1.97.

44. The method of claim 43, wherein x is greater than 1.98.

45. A method of making a AAAA battery, the method comprising:
incorporating a cathode including manganese dioxide that has been ozonated and an anode including zinc into a AAAA housing, wherein the weight ratio of manganese dioxide to zinc is less than 2.76.

46. The method of claim 45, wherein the weight ratio of manganese dioxide to zinc is less than 2.60.

47. The method of claim 45, wherein the manganese dioxide has a formula MnOₓ, where x is greater than 1.97.

48. The method of claim 47, wherein x is greater than 1.98.

49. A method of making a C battery, the method comprising:
incorporating a cathode including manganese dioxide that has been ozonated and an anode including zinc into a C housing, wherein the weight ratio of manganese dioxide to zinc is less than 2.28.

50. The method of claim 49, wherein the weight ratio of manganese dioxide to zinc is less than 2.22.

51. The method of claim 49, wherein the manganese dioxide has a formula MnOₓ, where x is greater than 1.97.

52. The method of claim 51, wherein x is greater than 1.98.

53. A method of making a D battery, the method comprising:
incorporating a cathode including manganese dioxide that has been ozonated and an anode including zinc into a D housing, wherein the weight ratio of manganese dioxide to zinc is less than 2.23.

54. The method of claim 53, wherein the weight ratio of manganese dioxide to zinc is less than 2.15.

55. The method of claim 53, wherein the weight ratio of manganese dioxide to zinc is less than 2.10.

56. The method of claim 53, wherein the manganese dioxide has a formula MnOₓ, where x is greater than 1.97.

57. The method of claim 56, wherein x is greater than 1.98.

58. AAA battery comprising:
a AA housing; and
an anode including zinc and a cathode including less than 10.00 grams of manganese dioxide;
wherein the AA battery has an available internal volume of greater than 6.1 cm³.

59. The AA battery of claim 58, wherein the AA battery has an available internal volume of greater than 6.2 cm³.

60. The AA battery of claim 58, wherein the AA battery has an available internal volume of greater than 6.3 cm³.

61. The AA battery of claim 58, wherein the AA battery has an available internal volume less than 7.5 cm³.

62. The AA battery of claim 58, wherein the battery includes a weight ratio of manganese dioxide to zinc of less than 2.30.

63. The AA battery of claim 58, wherein the manganese dioxide a formula MnOₓ, where x is greater than 1.97.

64. A method for making a AA battery, the method comprising:
incorporating a cathode including manganese dioxide that has been ozonated and an anode including zinc into a AA housing, wherein the AA battery has an available internal volume of greater than 6.10 cm³ and the manganese dioxide has a weight of less than 10.00 grams.

65. The AA battery of claim 64, wherein the manganese dioxide has been ozonated.
